(19) United States
(12) Patent Application Publication
(10) Pub. No.: US 2006/0161927 A1
(43) Pub. Date: Jul. 20, 2006

(54) Optical disk selecting apparatus

(76) Inventor: Hsin-Yuan Kuo, Kaohsiung County (TW)

Correspondence Address: Hsin-Yuan Kuo, 9F., No. 37, Dongsing Road, Xinyi District, Taipei City, 110, TW

(21) Appl. No.: 11/035,302

(22) Filed: Jan. 14, 2005

(51) Int. Cl. G11B 33/02

(52) U.S. Cl. 720/600

(57) ABSTRACT

The present invention discloses an optical disk selecting apparatus, which includes a support rack and a shaft, and the shaft is transversally disposed and supported by the support rack for serially moving optical disks so as to achieve the effect of selecting an optical disk quickly.

### FIELD OF THE INVENTION

The present invention relates to an optical disk selecting apparatus, and more particularly to an apparatus capable of selecting an optical disk quickly.

### BACKGROUND OF THE INVENTION

As the digital data processing capability of computers becomes more powerful, the computer applications enter into a multimedia world from the simple word processing function. To save and backup huge digital data, storage media change from traditional floppy disks to optical disks. Although the popular CD-R disk has a high capacity of up to 850 MB, a computer user usually needs several tens of optical disks to save or backup computer data. Further, the data storage such as an audio/video optical disk or a game optical disk used for storing multimedia data generally uses several optical disks as a package for its sale. Therefore, consumers need to have a convenient optical disk box or rack in order to properly store every optical disk or every set of optical disks.

Please refer to FIG. 1 for a schematic view of the structure of a prior-art optical disk box. In FIG. 1, the optical disk box 1 (also known as a pudding can in the market) comprises a base 11 and a cover barrel 12, wherein a vertical rod 111 is disposed vertically at the center of a surface of the base 11 for passing the optical disks 2 through the vertical rod 111 to stack the optical disks 2 serially, and providing a position limit effect. Then, the cover barrel 12 covers the base 11 for preventing dusts, and this type of optical disk box for storing optical disks can save the space occupied by the packing of optical disks. However, if a user wants to obtain a target optical disk stored at the bottom or in the middle of a series of optical disks, the user has to remove all optical disks 2 on top of the target optical disk before taking out the target optical disk, and then puts all removed optical disks 2 back into the vertical rod 111 one by one. Therefore, the closer the position of the target optical disk to the bottom, the longer time it takes for a user to recover the original storing status. Furthermore, the optical disks 2 are stacked vertically into a series and thus the optical disks 2 cannot be searched by index.

In view of the shortcomings of the prior-art optical disk box, the inventor of the present invention based on years of experience in the related field to conduct extensive researches and experiments to overcome the shortcomings and finally invented an optical disk selecting apparatus capable of picking up an optical disk quickly.

### SUMMARY OF THE INVENTION

Therefore, it is a primary objective of the present invention to design an optical disk selecting apparatus, so that an optical disk can be selected quickly by the simple design.

To achieve the foregoing objective, the optical disk selecting apparatus in accordance with the present invention includes a support rack and an axle member, and the axle member is transversally disposed by means of the axle member for moving the optical disks serially and achieving the effect of picking up a desired optical disk quickly.

### BRIEF DESCRIPTION OF THE DRAWINGS

FIG. 1 is a schematic view of a prior-art optical disk selecting box.

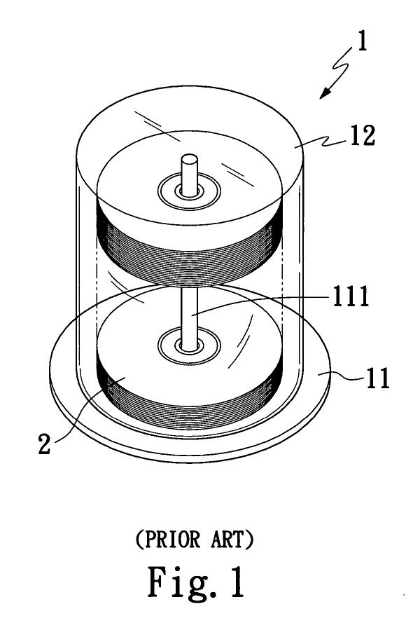

FIG. 2 is an exploded view of the structure of the present invention.

FIG. 3 is a schematic view of the movements of the present invention.

FIG. 4 is another schematic view of the movements of the present invention.

### DETAILED DESCRIPTION OF THE PREFERRED EMBODIMENTS

To make it easier for our examiner to understand the objective of the invention, its innovative features and performance, a detailed description and technical characteristics of the present invention are described together with the drawings as follows.

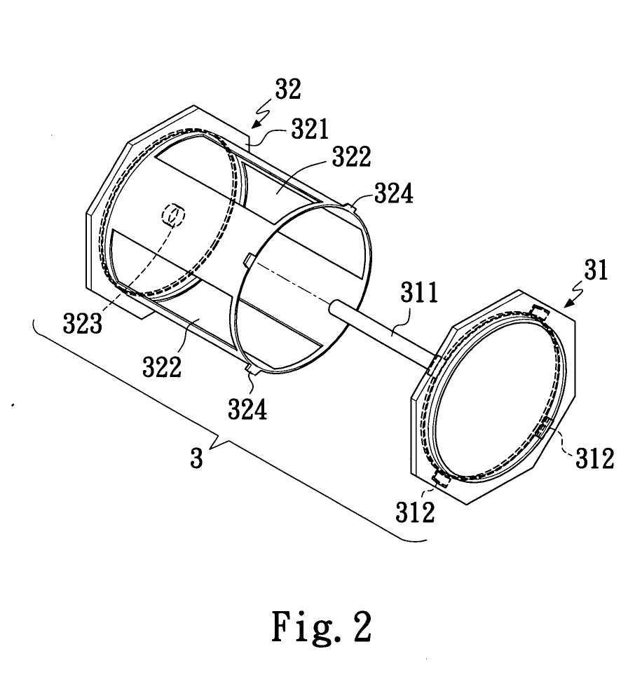

Please refer to FIG. 2 for the exploded view of the structure of the present invention. In FIG. 2, the optical disk selecting apparatus 3 of the present invention comprises an axle member 31; a central axle 311 disposed at the center of the axle member 31; and a support rod 32 having a plurality of indents 322 on its lateral side; wherein the axle member 31 is in a polygonal shape and includes a plurality of fasteners 312 disposed thereon; the top of the support rack 32 has a polygonal cap 321, and the cap 321 has an axle groove disposed at the center of the internal surface for allowing the corresponding central axle 311 to pass through. Further, the support rack 32 has a plurality of latches 324 disposed at the external side of the bottom of the support rack 32 and latched with the fasteners 312 to integrally couple the axle member 31 with the support rack 32.

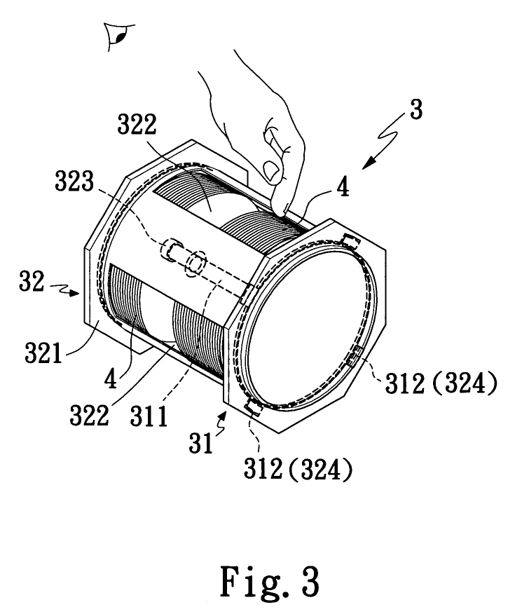

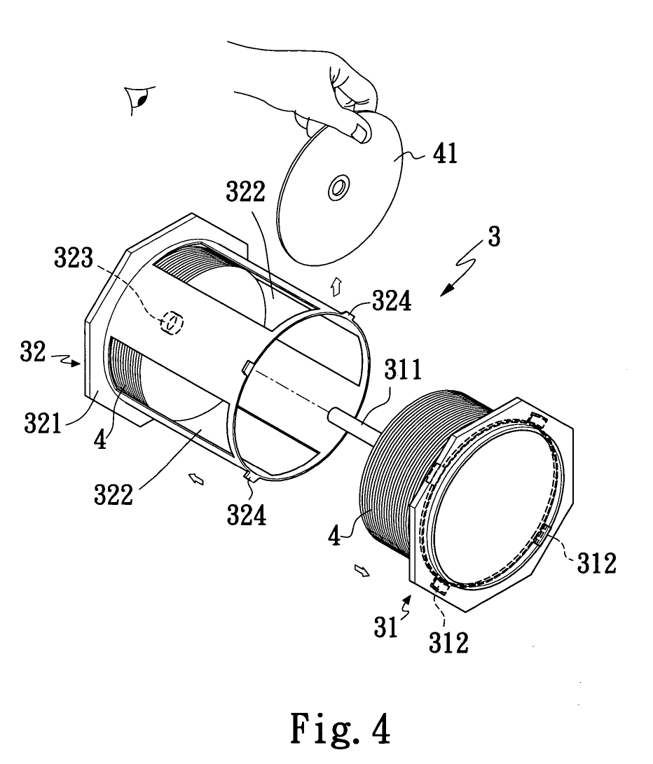

Please refer to FIGS. 3 and 4 for the schematic views of the movements according to the present invention. In the figures, if a user wants to pick up a target optical disk 41 from the optical disk selecting apparatus 3 of the present invention, the users places the optical disk selecting apparatus transversally and selects the optical disks 4 disposed on one end of the apparatus one by one through an indent on a lateral side of the support rack 32. Since the optical disk selecting apparatus 3 is placed transversally, the user can see an optical disk clearly to determine whether or not the selected optical disk is the target optical disk 41. If the selected optical disk is not the target optical disk 41, then push it to another end. After the target disk 41 is found, then the user can detach the axle member 31 from the support rack to take out the target optical disk 41 so as to complete the selection for this time. In addition, the design of the top of the axle member 31 and the support rack 32 has a polygonal cap 321 for preventing the optical disk selecting apparatus from rolling or sliding arbitrarily. With the aforementioned arrangement, the optical disk selecting apparatus of the present invention can achieve the effect of selecting a desired optical disk quickly.

In summation of the description above, the design of the optical disk selecting apparatus of the present invention is feasible and enhances the performance over the conventional structure and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical disk selecting apparatus, comprising a support rack and an axle, and said axle being transversally disposed by said support rack for serially moving an optical disk.

2. The optical disk selecting apparatus of claim 1, wherein said axle is in a polygonal shape.

3. The optical disk selecting apparatus of claim 1, wherein said axle member has a plurality of fasteners disposed thereon.

4. The optical disk selecting apparatus of claim 1, wherein said support rack has a plurality of indents disposed on its lateral side.

5. The optical disk selecting apparatus of claim 1, wherein said support rack has a plurality of latches disposed on the external side of the bottom of said support rack.

6. The optical disk selecting apparatus of claim 1, wherein said support rack has a polygonal cap at its top.

7. The optical disk selecting apparatus of claim 6, wherein said cap has an axle groove disposed at the center of an internal surface of said cap.
